(19) United States
(12) Patent Application Publication
(10) Pub. No.: US 2026/0303000 A1
(43) Pub. Date: Oct. 1, 2026

(54) Method and Apparatus for Increasing the Efficiency of and Reducing the Environmental Impact of Photovoltaic Panel Support Arrays

(71) Applicant: Geopier Foundation Company, Inc., Davidson, NC (US)

(72) Inventors: Kord J. Wissmann, Mooresville, NC (US); David J. White, Northfield, MN (US)

(73) Assignee: Geopier Foundation Company, Inc., Davidson, NC (US)

(21) Appl. No.: 19/474,859

(22) PCT Filed: Apr. 15, 2024
(86) PCT No.: PCT/US2024/024648

§ 371 Date: Oct. 13, 2025

Related U.S. Application Data
(60) Provisional application No. 63/459,337, filed on Apr. 14, 2023.

(51) Int. Cl. H02S 20/10

(52) U.S. Cl. CPC H02S 20/10

(57) ABSTRACT

A system, apparatus and method for increasing the efficiency of and reducing the environmental impact of photovoltaic panel support elements including a vertical panel support designed for embedment into soil or ground that has a load transfer element for increasing resistance on the applied vertical, lateral, and uplift loads of photovoltaic panels.

### CROSS-REFERENCE TO RELATED APPLICATIONS

This application is an International Application which claims the benefit of U.S. Provisional Patent Application Ser. No. 63/459,337 filed Apr. 14, 2024; the entire disclosure of which is incorporated herein by reference.

### TECHNICAL FIELD

The subject matter disclosed herein relates generally to photovoltaic (solar) energy farms, and more particularly to a system for and method of providing efficient foundation support that enhances the compressive, uplift, and lateral load resistance to increase cost-effectiveness and reduce environmental impacts of the support elements. The system and method reduces the volume of steel required for support, thereby reducing costs and providing a more environmentally beneficial support system.

### BACKGROUND

There are many traditional means and methods for providing support to structures used to support photovoltaic (solar) energy panel farms. Photovoltaic (PV) panels are used to harvest solar energy to generate electrical power. Because the PV panels replace the need to generate electrical power using other traditional methods, such as generators powered by the combustion of fossil fuels, they are environmentally more sensitive and have a much lower carbon consumption footprint than these traditional methods. PV panels are often located on rooftops and used to provide power for individual homes and buildings. PV panels may also be constructed in large numbers within a single PV panel farm consisting of thousands of side-by-side panels connected together to create a larger scale solar power plant. Because it is the intent of the construction of PV panel farms to reduce the environmental footprint associated with power production, it is also inherently important to reduce the environmental footprint of the support system required for construction.

In the majority of PV farm applications, each panel is typically supported by an individual vertical column. A series of panels is often tied together in one direction with a horizontal strut that provides lateral stability between the adjacent panels. The presence of the strut reduces the lateral load demand on the vertical support columns in the direction parallel to the axis of the lateral struts. Because of this, the vertical support column may be designed to be weaker in bending in plane of the lateral struts than it is in bending in the plane oriented orthogonally to the lateral struts.

The construction of PV farms consists therefor of providing vertical support for hundreds or thousands of adjacent panels with a support element that has preferential bending resistance in one direction. Because of the number of supports required, it is often most efficient to utilize steel sections, such as wide-flanged beams (“W” sections), or H-piles that provide for preferential bending resistance in one direction, are strong in compression, and are easy to connect with other steel elements by welding or bolting.

These sections are also readily driven into the ground and, because of this, provide for an opportunity to create construction speed efficiency through the construction of a unitary foundation/vertical support element. The W-or H-section is driven into the ground to a depth that provides sufficient foundation load carrying capacity support for vertical, lateral, and upload loads. The steel section is sized to extend the design distance into the ground and unitarily extend vertically out of the ground a prescribed distance to support the PV panel at the design elevation. In this way, the foundation and vertical support element are one in the same thus providing construction efficiency by eliminating the need for a connection between a subsurface foundation element and a surficial support element.

Although the installation of a unitary element provides great efficiency for construction, it leads to potential inefficiencies below-grade. In one example, the element could be structurally sized for maximum efficiency for the support of above-grade vertical support and also driven to an optimal below-grade depth to support this load. However, this same element may not be the most efficient for transmitting lateral loads to the adjacent soil or for resisting applied uplift loads. Should either the lateral or the uplift capacity be insufficient, a larger or longer section would be required, resulting in a larger volume of steel material needed and an increased associated environmental impact. Similarly, a selected H- or W-section may be optimally designed for resistance to lateral and uplift loads, but may be insufficient for supporting downward capacity loads, in which case, a larger or longer section is needed. It is the objective of the present subject matter to increase the below-grade lateral and vertical resistance of a unitary structural steel support element. It is a further objective of the present subject matter to reduce the environmental impact of the construction of PV farms by reducing the volume of steel required for the below ground foundation elements and by reducing the time and construction effort required for installation.

Using a similar approach, the slope stabilization method described in U.S. Pat. Nos. 7,090,440 and 7,811,032 provides enhancements to structural steel shapes used to resist lateral loads imposed by landslides and moving soil masses. U.S. Pat. Nos. 7,090,440 and 7,811,032 describe Plate Pile elements that consist of a structural shape (such as an H- or L-shaped section) that is enhanced by a plate that allows the sliding soil mass to “arch” to the closely spaced plates. The sliding soil mass is restrained by the presences of the vertically oriented plates that then transfer the soil loads to the pile stem which, in turn, transfers those loads to the soil below. The sliding soil mass translates horizontally to form a landslide in the absence of the Plate Pile elements. When Plate Piles are introduced, the loads applied by the sliding soil mass are transferred to the plates that then translates the upper portion of the Plate Piles horizontally. This horizontal deformation results in a horizontal load applied to the piling section at the elevation of the sliding mass that is then transferred from the pile to the underlying soil below-grade. The presence of the plates allows the Plate Piles to be spaced wider apart thus offering efficiencies in the volume of steel required. The art described in U.S. Pat. Nos. 7,090,440 and 7,811,032 are not applicable for use in PV solar panel farms, however, because the plates are used to enhance load transfer to the piles and are not conceived or implemented to enhance the resistance of the piles below-grade.

In an improvement to the Plate Pile system described above, U.S. Pat. No. 10,094,087 discloses a multi-plate piling system implemented to increase the efficiency of the Plate Pile system described above. Multiple plates are used to enhance vertical soil arching to the multiple plates thereby allowing for a reduction in the total volume of plate steel required. The application of multiple plates thus decreases the total cost of the Plate Pile system and reduces its environmental impact by reducing the amount of steel required for load transfer to the piles. U.S. Pat. No. 10,094,087 also discloses a multi-plate piling system wherein the lower plate is positioned to enhance the load transfer from the pile to the soil below. In this disclosure, the applied load from the sliding soil mass is resisted by the upper plate or plates and results in a horizontal movement of the pile that translates the same distance at the elevation of the sliding soil mass. The lower plate, which is located below the elevation of the sliding surface, reduces the total lateral movement of the pile and results in an increase in efficiency. The multiple Plate Pile system is limited in use to sliding slopes and not applicable to PV solar panel farms because PV solar panel supports do not require resistance to lateral soil movements and thus do not require upper plates and beams and because the lateral loads applied to PV panel farms stem from structural loads applied well above-grade that result in shear loads and bending loads at the ground surface elevation, a load combination and pile bending condition that is significantly different than lateral soil movement-induced loads. Further, the difference in the constraints on the upper portion of the piles, the lateral loads, and the applied bending moments result in an appreciable difference in the efficacy of below-grade load transfer that results in great differences in efficient load resistance.

### SUMMARY

The present subject matter provides for an efficient system and method for supporting PV solar panel arrays that reduces the volume, cost, and environmental impact of the steel support system required for construction. The system and method may include driving one or more unitary PV panel support elements into the foundation soil to a depth whereby satisfactory resistance to the applied vertical, lateral, and upload loads is reached. The system and method may be comprised of structural steel shapes that are improved with compression, uplift, and lateral enhancing elements that may be used individually or in combination to more efficiently resist compression, lateral, and uplift loads. The implementation of the present subject matter results in the use of support elements that are shorter and lighter than traditional members. This art provides a more efficient support system that results in a reduction of the volume of structural steel required and corresponding reductions in cost and environmental impact.

Photovoltaic (PV) panels are used to harvest solar energy to product electricity. The panels are often installed on the roofs of buildings such as houses or commercial structures and used to provide power the building or other structure. In some locations, these panels may be connected to the local electric grid with the benefit that the distributed panels supply energy to the grid thus reducing the dependence on the combustion of fossil fuels for energy production. Because the procurement and installation of the panels is relatively expensive, the main impetus for their use is to reduce the environmental impact of fossil fuel derived energy. It is the goal of many countries to become carbon neutral by the year 2050 and the implementation and use of PV panels for electrical energy production is a tangible part of this strategy.

PV panels may also be constructed side-by-side to form PV panel “farms” that operate as concentrated power plants. Individual farms may cover many contiguous acres of land with panels numbering in the hundreds and sometimes thousands. Panel farms are typically installed on steel racks consisting of vertical and lateral support systems. Often each individual panel is supported by a unitary pile that is driven into the ground a prescribed distance sufficient to resist downward compression, lateral, and upward tension loads.

The use of a unitary pile section for both the upper, above-grade, portion and the lower, below-grade, portion is desired for ease of construction and so that costly connections are avoided. This unitary section, however, may not be optimal for all load conditions. For example, for a given unitary section with size and properties selected for efficient above-ground load support, there exists an optimal depth in which the vertical compressive (also known as “bearing”) loads are most efficiently supported. Piles that are driven less than this depth are too short to resist the downwardly applied compression loads; piles that are driven more than this depth are too long to be optimally efficient.

However, the optimal depth for the support of compression loads is unlikely to be optimal for the support of lateral and uplift loads, which are applied and computed separately.

In the example above, if the most efficient structural shape is driven to the most efficient depth for the support of downward compression loads, and if this depth is then found to be too shallow to optimally resist upward tensile loads, then the pile would need to extend to a greater depth that is now too long for optimal compressive load efficiency. In the same way, if the most efficient structural shape for above ground support is then deemed insufficient to transfer lateral loads to the ground, then a larger section would be required that is not optimally efficient for above ground support. It would be a very rare installation for a traditional pile shape selected for optimal above-ground support to be in-turn optimally designed for below-ground load transfer.

In the present subject matter, a system and method for the optimal support of PV panel farms with a unitary piling system is provided. In one embodiment, the system and method is comprised of elements used to enhance the downward compressive capacity of the support member. In another embodiment, the system and method is comprised of elements used to enhance the lateral load resistance of PV panel support elements. In this embodiment, the lateral load resistance is provided by configuring below-grade load and bending moment transfer elements to the support element. The enhancements may be comprised of structural steel shapes that are used to more efficiently transfer the applied load and bending moment at a reduced deflection. In this embodiment, the weight of the steel section used to transmit lateral loads may be reduced. This allows for a lighter steel section that requires less steel and is easier to install. The present subject matter results in cost savings and a reduced environmental footprint.

In another embodiment, the system and method is comprised of another configuration of elements used to enhance the upward load resistance of PV panel supports. In this embodiment, the upward load resistance is enhanced by providing structural elements affixed to the pile near the tip of the pile. These structural elements may be comprised of shapes configured from steel or other material to increase the inverted load capacity of upwardly moving steel support members.

In another embodiment, the system and method may include a photovoltaic panel support system having a piling element adapted to extend to a depth into a ground and support a panel rack above the ground. In one exemplary embodiment, the piling element may have a web spanning between two flanges and may be provided with a panel rack height, an embedment length, a compression load, an uplift load, and a lateral load. In another exemplary embodiment, the load transfer element may be provided to the piling element and adapted to increase resistance to one or more of the compression, uplift, and lateral loads.

In still another embodiment, the system and method may include a photovoltaic panel support apparatus. In one exemplary embodiment, the PV panel support apparatus may have a panel rack attached to one or more panels, a vertical support section adapted for embedment into a ground and for supporting the one or more panels above the ground, and a load transfer section provided to the vertical support section. The vertical support section may have a panel rack height, an embedment length, a compression load, an uplift load, and a lateral load. The load transfer section may be adapted to increase resistance to one or more of the compression, uplift, and lateral loads.

In yet another embodiment, the system and method may include a method of constructing a photovoltaic panel farm. In one exemplary embodiment, and method may include the steps of: providing a series of photovoltaic panels, a panel rack, and a panel support; embedding the panel support into a ground; and attaching the photovoltaic panels and panel rack to the panel support, the panel support having a piling section and a load transfer section. In one exemplary method, the piling section may be adapted to extend to a depth into a ground and support the panel rack above the ground. The piling section may have a web spanning between two flanges and may be provided with a panel rack height, an embedment length, a compression load, an uplift load, and a lateral load. The load transfer section may be provided to the piling section and adapted to increase resistance to one or more of the compression, uplift, and lateral loads.

The embodiments described herein result in a small incremental increase in the volume of steel support required to fabricate and affix the enhancing element to the steel pile but result in an overall reduction of the weight and length of the installed piling section. This weight reduction results in less steel required and a corresponding reduction in the environmental footprint.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1A and FIG. 1B illustrate a traditional photovoltaic panel farm array consisting of utilizing a conventional wide-flanged “W-beam” or “H-Pile” section (prior art).

FIG. 2A, FIG. 2B, and FIG. 2C illustrate a traditional method used to support and describe the loads applied to a photovoltaic panel farm, wherein this method consists of utilizing a conventional wide-flanged “W-beam” or “H-Pile” section (prior art).

FIG. 3A, FIG. 3B, and FIG. 3C illustrate an enhanced apparatus and method, wherein this configuration includes a traditional steel support section comprised of a W-beam or an H-pile, and a configuration of a compressive resistance support system used to create a more efficient, cost-effective, and environmentally friendly design.

FIG. 4A, FIG. 4B, FIG. 4C, and FIG. 4D illustrate another embodiment of an enhanced apparatus and method, wherein this configuration includes a traditional steel support section comprised of a W-beam or an H-pile, and a configuration of a compressive resistance support system used to create a more efficient, cost-effective, and environmentally friendly design.

FIG. 5A, FIG. 5B, and FIG. 5C illustrate another example of an enhanced apparatus and method, wherein this configuration includes a traditional steel support section comprised of a W-beam or an H-pile and a second uplift resistance support plate system used to create a more efficient, cost-effective, and environmentally friendly design.

FIG. 6A, FIG. 6B, FIG. 6C, FIG. 6D, and FIG. 6E illustrate another example of an enhanced apparatus and method, wherein this configuration includes a traditional steel support section comprised of a W-beam or an H-pile and another configuration of an uplift resistance support system used to create a more efficient, cost-effective, and environmentally friendly design.

FIG. 7A, FIG. 7B, and FIG. 7C illustrate another example of an enhanced apparatus and method, wherein this configuration includes a traditional steel support section comprised of a W-beam or an H-pile and another configuration of an uplift resistance support system used to create a more efficient, cost-effective, and environmentally friendly design.

FIG. 8A, FIG. 8B, and FIG. 8C illustrate another example of an enhanced apparatus and method, wherein this configuration includes a traditional steel support section comprised of a W-beam or an H-pile and another configuration of a lateral resistance support system used to create a more efficient, cost-effective, and environmentally friendly design.

FIG. 9A, FIG. 9B, and FIG. 9C illustrate an example of an enhanced apparatus and method, wherein this configuration includes a traditional steel support section comprised of a W-beam or an H-pile and a lateral resistance support plate used to create a more efficient, cost-effective, and environmentally friendly design.

FIG. 10A, FIG. 10B, and FIG. 10C illustrate another example of an enhanced apparatus and method, wherein this configuration includes a traditional steel support section comprised of a W-beam or an H-pile, and a lateral resistance support system used to create a more efficient, cost-effective, and environmentally friendly design.

FIG. 11 is a plot that shows the results of compressive load tests performed on two traditional steel support sections as described in Example 1, one with load transfer elements shown in FIGS. 4A, 4B, 4C, and 4D installed in the steel support section and one without load transfer elements installed in the steel support section.

FIG. 12 is a plot that shows the results of additional compressive load tests performed on two traditional steel support sections as described in Example 1, one with load transfer elements shown in FIGS. 4A, 4B, 4C, and 4D installed in the steel support section and one without load transfer elements installed in the steel support section.

FIG. 13 is a plot that shows the results of further compressive load tests performed on two traditional steel support sections as described in Example 1, one with load transfer elements shown in FIGS. 4A, 4B, 4C, and 4D installed in the steel support section and one without load transfer elements installed in the steel support section.

FIG. 14 is a plot that shows the results of uplift load tests performed on three traditional steel support sections as described in Example 2, two with load transfer elements shown in FIGS. 6A, 6B, 6C, 6D, and 6E installed in the steel support sections and one without load transfer elements installed in the steel support section.

FIG. 15 is a plot that shows the results of lateral load tests performed on two traditional steel support sections as described in Example 3, one with a load transfer element shown in FIGS. 10A, 10B, and 10C installed in the steel support section and one without a load transfer element installed in the steel support section.

FIG. 16 is a plot that shows the results of additional lateral load tests performed on two traditional steel support sections as described in Example 3, one with a load transfer element shown in FIGS. 10A, 10B, and 10C installed in the steel support section and one without a load transfer element installed in the steel support section.

FIGS. 17A, 17B, and 17C show the pile sections used in a numerical analysis investigating the lateral load capacity increase of three piling sections described in Example 4, one without a load transfer element, one with a load transfer element shown in FIGS. 8A, 8B, and 8C, and one with a load transfer element shown in FIGS. 9A, 9B, and 9C.

FIG. 18 is a plot that shows the results of a numerical analysis investigating the lateral load capacity increase conducted on the three pile sections shown in FIGS. 17A, 17B, and 17C and as described in Example 4.

### DETAILED DESCRIPTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

In other embodiments, the presently disclosed subject matter provides a system for and method of improving the performance, reducing the installation costs, and reducing the environmental impact of PV panel support systems using one or more uplift enhancement elements, wherein each of the uplift enhancement elements, in one example, comprises an uplift enhancement wedge that provides greater uplift resistance in comparison to traditional non-enhanced pilings. The one or more uplift enhancement plates allow for an inverted bearing capacity to develop along the bottom of the piling element to enhance the uplift resistance by increasing the uplift efficiency thereby reducing piling depth required to resist the applied uplift loads associated with, for example, wind loads or seismic shaking.

In one embodiment, a single wedge-shaped element is implemented to increase uplift resistance. In other embodiments, multiple wedge-shaped elements are implemented to increase uplift resistance. In another embodiment, a dual-action wedge is implemented to enhance uplift resistance. For each of these embodiments, the implementation of the uplift enhancement elements allows for a reduction in the required length of the piling shaft which transfers uplift loads to the soils in friction only without the enhancement benefit of additional inverted bearing capacity. The reduction in the length of the piling element often results in a greater reduction of piling volume than is associated with the incremental addition of the enhancement elements. In these embodiments, the cost of the support element and the environmental footprint associated with the production and fabrication of the steel shapes is reduced.

In another embodiment, the presently disclosed subject matter provides a system for and method of improving the performance, reducing the installation costs, and reducing the environmental impact of PV panel support systems using one or more lateral support elements, wherein each of the support elements, in one example, comprises one or more compressive transfer plates to improve the downward load carrying performance in soft or unstable soil materials. The one or more lateral transfer plates transfer applied lateral forces, in many cases consisting of wind forces applied to the PV panel, to the subsurface soil improving the load-transfer response by increasing the transfer area and thereby reducing the load transfer stresses allowing for equivalent load transfer with lower total lateral deformations.

In one embodiment, a single rectangular-shaped load transfer element is implemented to reduce lateral deformation. In another embodiment, a single triangular shaped load transfer element is implemented to reduce lateral deformation. For each of these embodiments, the implementation of the load transfer plate or plates allows for a reduction of the section modulus (i.e. cross-sectional area) along the piling element whereby the volume reduction of steel or other material from the reduced section modulus is greater than the volume of steel required in the transfer plate. In these embodiments, the cost of the support element and the environmental footprint associated with the production and fabrication of the steel shapes is reduced.

In another embodiment, the system and method may include a photovoltaic panel support system having a piling element adapted to extend to a depth into a ground and support a panel rack above the ground. In one exemplary embodiment, the piling element may have a web spanning between two flanges and may be provided with a panel rack height, an embedment length, a compression load, an uplift load, and a lateral load. In another exemplary embodiment, the load transfer element may be provided to the piling element and adapted to increase resistance to one or more of the compression, uplift, and lateral loads.

In still another embodiment, the system and method may include photovoltaic panel support apparatus. In one exemplary embodiment, the PV panel support apparatus may have a panel rack attached to one or more panels, a vertical support section adapted for embedment into a ground and for supporting the one or more panels above the ground, and a load transfer section provided to the vertical support section. The vertical support section may have a panel rack height, an embedment length, a compression load, an uplift load, and a lateral load. The load transfer section may be adapted to adapted to increase resistance to one or more of the compression, uplift, and lateral loads.

In yet another embodiment, the system and method may include a method of constructing a photovoltaic panel farm. In one exemplary embodiment, and method may include the steps of: providing a series of photovoltaic panels, a panel rack and a panel support; embedding the panel support into a ground; and attaching the photovoltaic panels and panel rack to the panel support the panel support having a piling section and a load transfer section. In one exemplary method, the piling section may be adapted to extend to a depth into a ground and support the panel rack above the ground. The piling section may have a web spanning between two flanges and may be provided with a panel rack height, an embedment length, a compression load, an uplift load, and a lateral load. The load transfer section may be provided to the piling section and adapted to increase resistance to one or more of the compression, uplift, and lateral loads.

An aspect of the presently disclosed system and method that use the one or more load transfer enhancement apparatuses is that it can be used for more efficiently supporting large scale PV panel farms by reducing the volume of construction materials, cost, and environmental footprint of the installed systems.

Another aspect of the presently disclosed system and method that use the one or more load transfer apparatuses is that it overcomes the inefficiency of conventional systems by providing soil load transfer elements that are designed to efficiently transfer the applied loads from the pile to the soft soil profile.

Yet another aspect of the presently disclosed system and method that use the one or more load transfer apparatuses is that it is efficient and economical to install because excessively thick and wide traditional steel sections are not required to be installed. Thus, cost efficiencies resulting from both construction method and construction material usage result in lower construction costs and a lessening of the depletion of natural resources used for stabilization.

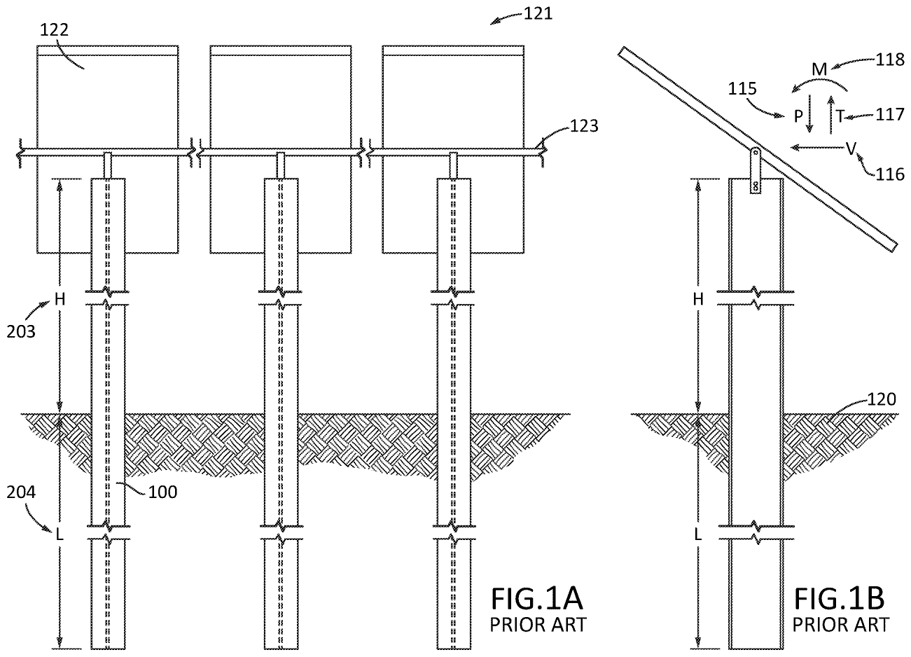

Referring now to FIG. 1 an example configuration of a PV panel apparatus configured into a rack arrangement 121 with three supported PV panels 122 (prior art). The configuration is constructed by attaching multiple panels 122 to a panel rack 123. The panel rack 123 may support a few or many panels, such as 20 individual panels, and generally extends linearly in one plan view direction. Each panel 122 is generally supported by one vertical support 100 and connected to adjacent panels in one plan view direction. The racks are loaded by vertical (gravity) (P) loads 115, horizontal (V) loads 116 that emanate from wind or seismic forces, and wind-or seismic-generated uplift (T) loads 117. Because of the lateral support offered by the rack 123 in one plan view direction, the individual panel loads in that direction are lower and the support may be designed to be weaker in that direction. Thus, the vertical supports 100 beneath each panel 122 are loaded by the weight of the panel 122, a weak lateral force in the direction of the rack alignment, a relatively strong lateral force oriented transverse to the plan view rack direction, and an uplift force generated by wind or seismic loads.

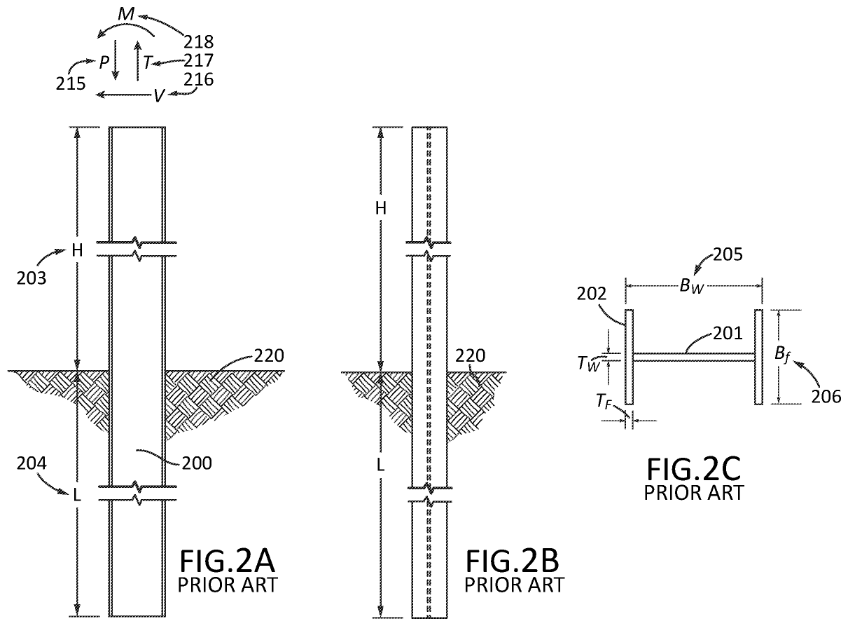

Referring now to FIG. 2A, FIG. 2B, and FIG. 2C an example configuration of a steel H-piling or W-section 200 used to transfer superstructure loads to the soil below-grade (prior art). The piling section 200 often used in the prior art consists of a rolled steel section comprised of a web 201 spanning between two flanges 202. The web 201 has a width (Bw) 205 and a thickness (Tw). The flanges 202 have a width (Bf) 206 and a thickness (Tf). The structural sections 200 shown in FIG. 2A, FIG. 2B, and FIG. 2C that comprise the prior art have a constant weight (W) over each unit length of the pile and a constant section modulus(S) over the unit length of the pile. The weight (W) per unit length of the pile determines the volume of steel required to fabricate the shape; higher weight sections require more steel. The section modulus(S) of the pile determines its resistance to bending.

The piling section 200 shown in FIG. 2A, FIG. 2B, and FIG. 2C is driven into the ground a sufficient depth such that the applied loads are resisted appropriately. The piling section 200 thus performs as both the foundation element below-grade and the superstructure support element. Using a unitary section 200 provides great efficiency for construction because construction time-consuming and labor-intensive connections are not required between the foundation and superstructure.

Bending occurs when a lateral load is applied at the top of the pile section, for example the lateral load applied by wind forces, and when that load is transferred from the top of the pile to any location below the top of the pile. The bending moment (M) 218 is computed as the product of the applied lateral load (V) 216 and the distance (H) 203 from the top of the pile to that location. For example, in FIG. 2A, FIG. 2B, and FIG. 2C, the bending moment (M) 218 in the piling section 200 computed at the ground surfaced is the product of the applied lateral load (V) 216 and the length of the pile (H) 203 extending from the ground surface to the top of the pile. The resistance to bending is provided by the section modulus(S) of the piling. Larger pilings have larger section modulus values and smaller pilings have smaller section modulus value. The section modulus of the piling shape is largely dependent on the width of the web (Bw) 205 and the area of the flanges, defined approximately as the product of (Bf) 206 and Tf. For maximum bending efficiency, piling designers attempt to choose commercially available piling sections that maximize the section modulus(S) while minimizing the unit weight, (W).

The piling section 200 shown in FIG. 2A, FIG. 2B, and FIG. 2C is initially sized such that it is large and strong enough to resist vertical downward and upward loads. An efficient design minimizes the weight (W) of the section while providing adequate structural capacity. The section is then sized to be large and strong enough to resist lateral loads. An efficient design provides a sufficient section modulus(S) in both the weakly loaded (in plan view direction of the rack) direction and the strongly loaded (transverse to plan view orientation of the rack) direction. The conventional use of H-and W-sections provides the opportunity to create efficient designs in the vertical, weak horizontal, and strong horizontal directions.

Once the appropriate section for resisting superstructure loads is determined, the piling section 200 shown in FIG. 2A, FIG. 2B, and FIG. 2C is then designed to extend to an appropriate depth (L) 204 into the ground 220 such that adequate resistance to compression (gravity), uplift, and lateral loads is achieved. The length of the pile below-grade (L) is generally controlled by compression (P) load 215 and uplift (T) load 217 demands. These loads are resisted by friction that develops between the steel section and the adjacent soil. Sections that are wider in either plan view direction, (Bw) 205 or (Bf) 206, or deeper exhibit greater compression and uplift load resistance. Design efficiencies can be achieved if the length (L) required to resist downward compression or uplift loads (T) 217 is reduced. These design efficiencies are most beneficial at sites containing soft or weak soil profiles. The lateral response of the piling section is also then designed so that the pile has adequate lateral load resistance occurring at an acceptable deflection level for the PV panel farm system. In soft or weak soil profiles, the ground surrounding the PV panel pile may not have sufficient strength to adequately resist the lateral loads. For these profiles, a larger, stronger, and stiffer section with a higher section modulus (S) and higher unit weight (W) are selected. Design efficiencies can be achieved in these cases if the originally designed efficient section may be used in soft and weak ground.

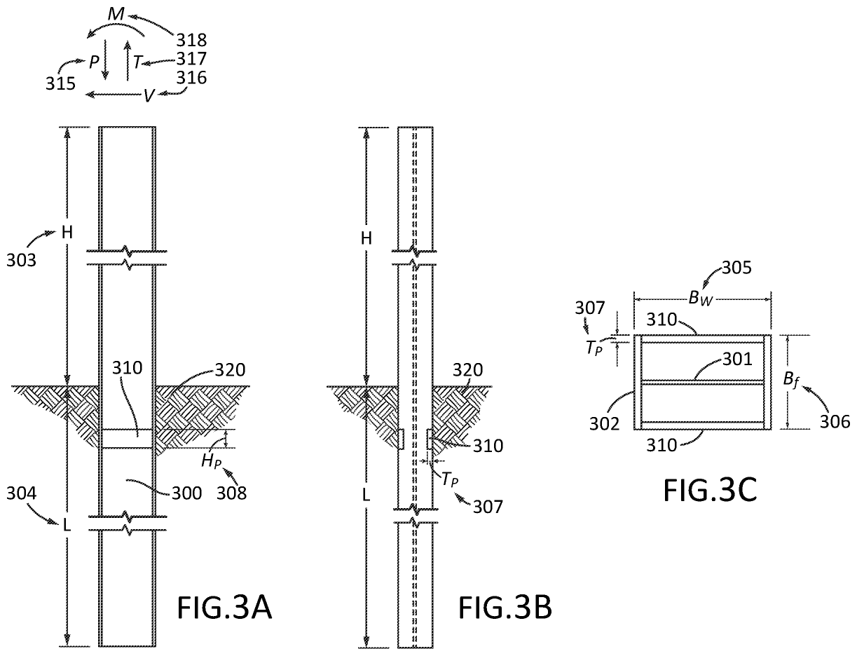

Referring now to FIG. 3A, FIG. 3B, and FIG. 3C an example configuration of an embodiment of the present subject matter comprising a piling section 300 having a piling web 301 spanning between piling flanges 302, with a provided rack height 303, and provided compression (P) 315, uplift or tension (T) 317, and lateral (V) 316 loads, and provided design dimensions (Bw) 305 and (Bf) 306 and properties (W) and (S) efficiently determined based on superstructure rack loads. The load transfer element 310 has a thickness (Tp) 307 and a height (Hp) 308. In this embodiment, the load transfer element 310 is provided to the piling section 300 to enhance its resistance to compression loads 315 in the soil profile with the consequence of a reduced embedment length 304 into the ground 320. The load transfer element 310 may be comprised of a pair of plates welded inside each of the piling flanges 302 to provide greater resistance to compressive loads. These plates will increase the resistance while driving and act as an end bearing element, resulting in increased resistance to compressive loads.

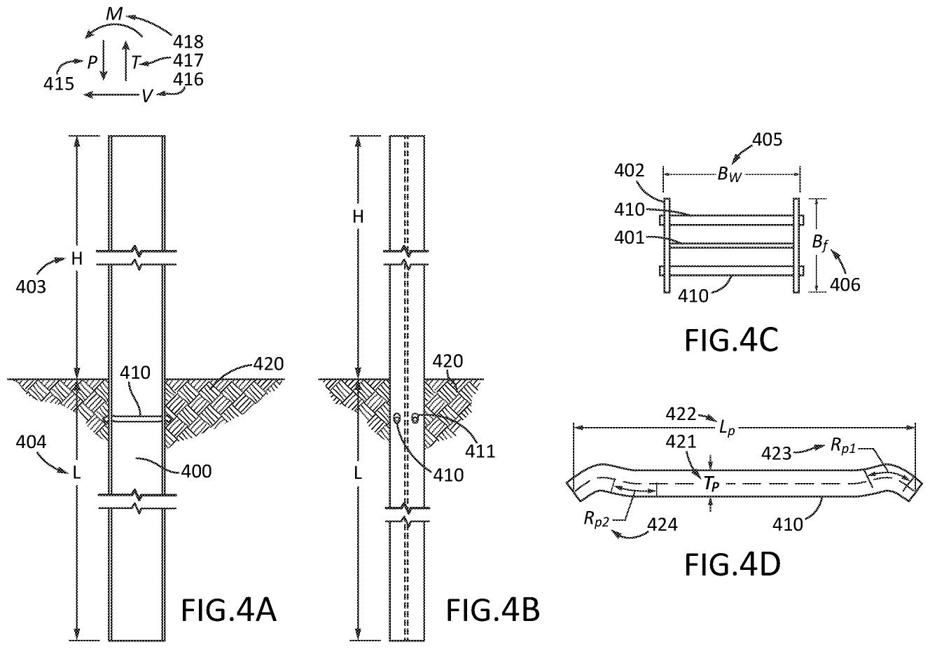

Referring now to FIG. 4A, FIG. 4B, FIG. 4C, and FIG. 4D an example configuration of another embodiment of the present subject matter comprised of a piling section 400 having a piling web 401 spanning between piling flanges 402, with a provided rack height 403, and provided compression (P) 415, uplift or tension (T) 417, and lateral (V) 416 loads, and a design dimensions (Bw) 405 and (Bf) 406 and properties (W) and (S) efficiently determined based on superstructure rack loads. In this embodiment, a compression load transfer element 410 is provided to the piling section to enhance its resistance to compression loads 415 in the soil profile with the consequence of a reduced embedment length 404 into the ground 420. The load transfer element 410 is a specially designed section of steel rebar that spans the design flange width 405 and has a thickness (Tp) 421, length (Lp) 422, and curves (Rp1) 423 and (Rp2) 424 shown in FIG. 4D. This load transfer element 410 is installed within holes 411 cut into the piling flanges 402. The curves 423 and 424 allow the installation of the load transfer element 410 into the holes 411 cut into the piling flanges 402. The curves 423 and 424 further enhance the load transfer element 410 by securing the load transfer element 410 within the piling flanges 402 during driving. As the piling element 400 is driven into the ground 420, the foundation soil moves up into the area of the bottom of the pile subtended by the piling web 401 and the piling flange 402. The load transfer element 410 directs the soil plug to move towards the outside of the pile area. This action pushes the soil outwardly, not upwardly, as the piling element 400 is driven downwards. The outward movements of the soil increase the pressure in the ground 420 outside the piling element 400 thereby building up lateral stress. As the lateral stress in the ground 420 is increased, the friction between the steel piling and the soil is also increased, resulting in a larger compressive load resistance relative to a pile 400 not equipped with the load transfer element 410. In this embodiment, field construction expediency is enhanced by the load transfer element 410 allowing for a shorter piling element 400 to be used as well as the curves 423 and 424 preventing the need for welding of the load transfer element 410 to the piling section 400.

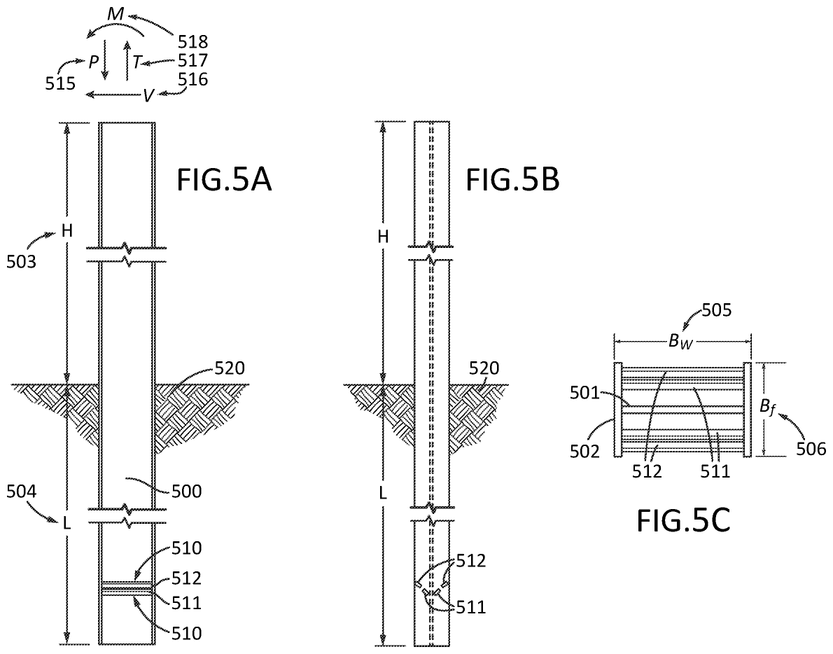

Referring now to FIG. 5A, FIG. 5B, and FIG. 5C an example configuration of another embodiment of the present subject matter comprised of a piling section 500 having a piling web 501 spanning between piling flanges 502, with a provided rack height 503, and provided compression (P) 515, uplift or tension (T) 517, and lateral (V) 516 loads, and a design dimensions (Bw) 505 and (Bf) 506 and properties (W) and(S) efficiently determined based on superstructure rack loads. In this embodiment, an uplift load transfer element 510 is provided to the piling section to enhance its resistance to uplift loads in the soil profile with the consequence of a reduced embedment length 504 into the ground 520. The load transfer element 510 may be comprised of a pair of steel attachments that work in tandem to increase the uplift load resistance of the pile element 500. The load transfer element 510 may be comprised of an inner plate 511 and an outer plate 512 located in the area between the piling web 501 and the piling flange 502. The inner plate 511 is located in a proximal position towards the web 501 and the outer plate 512 is located in a distal position away from the web 501. As the piling element 500 is driven into the ground 520, the foundation soil moves up into the area of the bottom of the pile subtended by the piling web 501 and the piling flange 502. The inner plate 511 directs the soil plug to move towards the outside of the pile area and the outer plate 512 directs the soil plug to move outward and upward. This action pushes the soil outwardly, not upwardly, as the piling element 500 is driven downwards. The outward movements of the soil increase the pressure in the ground 520 outside the piling element 500 thereby building up lateral stress. As the lateral stress in the ground 520 is increased, the friction between the steel piling and the soil is also increased resulting in a larger uplift resistance relative to a pile 500 not equipped with the apparatus 510.

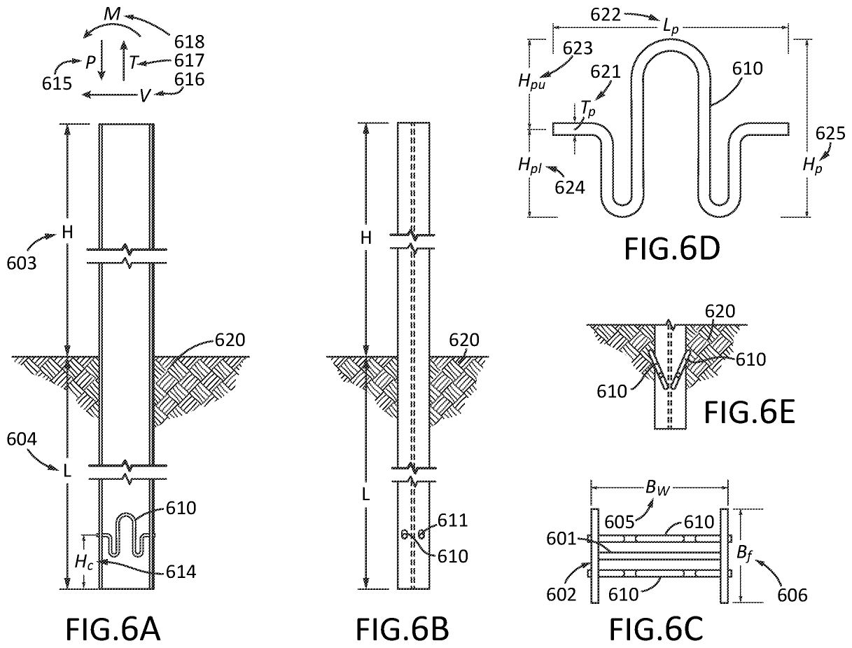

Referring now to FIG. 6A, FIG. 6B, and FIG. 6C an example configuration of another embodiment of the present subject matter comprising a piling section 600 having a piling web 601 spanning between piling flanges 602, with a provided rack height 603, and provided compression (P) 615, uplift or tension (T) 617, and lateral (V) 6161 loads, and provided design dimensions (Bw) 605 and (Bf) 606 and properties (W) and(S) efficiently determined based on superstructure rack loads. In this embodiment, a load transfer element 610 is provided to the piling section 600 to enhance its resistance to uplift loads 617 in the soil profile with the consequence of a reduced embedment length 604 into the ground 620. The load transfer elements 610 may be comprised of a section of steel, such as a steel rebar, that is curved, or serpentine shaped, and placed within holes 611 cut into the piling flanges 602. The load transfer element 610 has a thickness (Tp) 621, length (Lp) 622, an upper arm height (Hpu) 623, a lower arm height (Hpl) 624, and an overall height (Hp) 625 shown in FIG. 6D. In this embodiment, the load transfer element 610 remains vertical during downward driving of the piling section 600, providing minimal resistance to driving. During uplift loading 617, the load transfer element 610 rotates within the piling flanges 602 so that the top of the load transfer element 610 splay outwards. FIG. 6E shows a cross section view of an installed piling section 600 that illustrates how full rotation of the load transfer element 610 is prevented when the geometrically configured lower arm height 624 makes contact with the piling web 601, halting further rotation. The outward rotation of the top of the load transfer element 610 increases the uplift load resistance by creating a wedge of soil above the load transfer element 610.

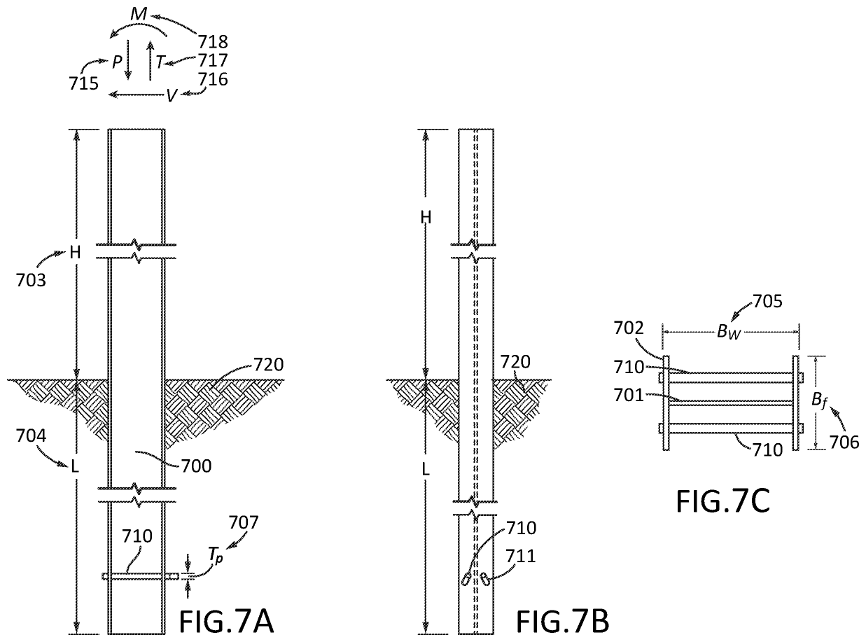

Referring now to FIG. 7A, FIG. 7B, and FIG. 7C an example configuration of yet another embodiment of the present subject matter comprised of a piling section 700 having a piling web 701 spanning between piling flanges 702, with a provided rack height 703, and provided compression (P) 715, uplift or tension (T) 717, and lateral (V) 716 loads, and a design dimensions (Bw) 705 and (Bf) 706 and properties (W) and(S) efficiently determined based on superstructure rack loads. In this embodiment, the load transfer element 710 is a specially designed section of steel rebar with a thickness (Tp) 707 that spans the design flange width (Bw) 705 to enhance its resistance to uplift loads in the soil profile with the consequence of a reduced embedment length 704 into the ground 720. The load transfer element 710 may be installed within upwardly inclined slots 711 that are cut in the piling flanges 702. In one embodiment, the load transfer element 710 may be allowed to translate upward and downward in the inclined slots 711. During driving of the piling section 700 the resistance provided by the soil results in the load transfer element 710 translating to the top of the inclined slots 711 close to the web 701 of the piling section 700, which results in little additional resistance during driving. When uplift has been applied, the load transfer element 710 translates downward along the inclined slot 711 and away from the web 701 of the piling section 700. This engages the wedge of soil above the load transfer element 710 that then increases the uplift resistance.

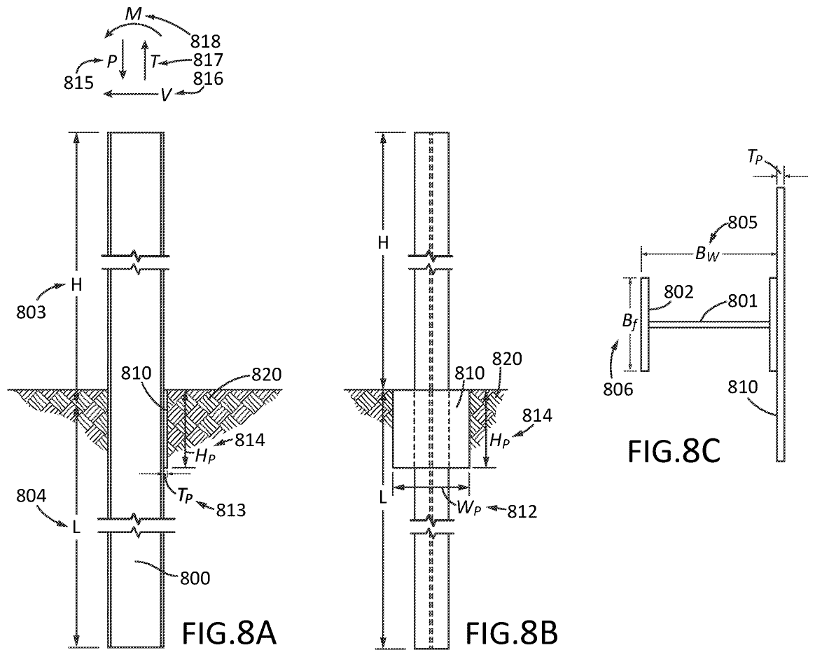

Referring now to FIG. 8A, FIG. 8B, and FIG. 8C an example configuration of another embodiment of the present subject matter comprised of a piling section 800 having a piling web 801 spanning between piling flanges 802, with a provided rack height 803, and provided compression (P) 815, uplift or tension (T) 817, and lateral (V) 816 loads, and a design dimensions (Bw) 805 and (Bf) 806 and properties (W) and(S) efficiently determined based on superstructure rack loads. In this embodiment, still yet another load transfer element 810 is provided to the piling section to enhance its resistance to lateral loads 816 and bending moments (M) 818 in the soil profile. The current embodiment is comprised of a lateral load transfer element 810 shown in FIG. 8A, FIG. 8B, and FIG. 8C as a generally rectangular shaped plate 810 welded or otherwise attached to the piling element 800 outside one of the flanges 802. The lateral load transfer device 810 shown in FIG. 8A, FIG. 8B, and FIG. 8C has a height (Hp) 814, a width (Wp) 812 and a thickness (Tp) 813. The dimensions of the plate are selected for optimal performance and minimum cost. The load transfer element 810 generally extends from the ground surface downward into the ground 820. The presence of the load transfer element 810 serves to increase the effective width (Bf) 806 of the flange of the piling element 800 over the depth below-grade as defined by height (Hp) 814. When loaded by lateral loads 816 and bending moments 818 the presence of the load transfer element 810 effectively increases the piling 800 width and reduces the amount of deflection associated with a given lateral load 816 or applied bending moment 818. In soft ground, this allows a smaller piling section to be used in comparison to that required to resist the lateral loads without the load transfer element. This allows for the selection of more efficient piling sections with a lower unit weight (W) and a lower section modulus(S).

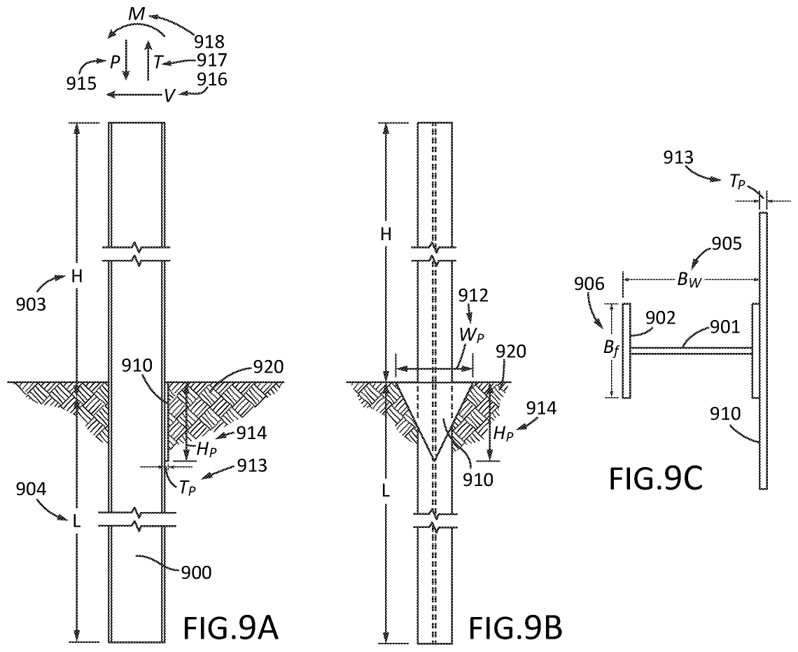

Referring now to FIG. 9A, FIG. 9B, and FIG. 9C an example configuration of still another embodiment of the present subject matter comprised of a piling section 900 having a piling web 901 spanning between piling flanges 902, with a provided rack height 903, and provided compression (P) 915, uplift or tension (T) 917, and lateral (V) 916 loads, and a design dimensions (Bw) 905 and (Bf) 906 and properties (W) and(S) efficiently determined based on superstructure rack loads. In this embodiment, still yet another load transfer element 910 is provided to the piling section to enhance its resistance to lateral loads 916 and bending moments (M) 918 in the soil profile. The current embodiment is comprised of a lateral load transfer element 910 shown in FIG. 9A, FIG. 9B, and FIG. 9C as a generally triangular shaped plate 910 welded or otherwise attached to the piling element 900. The lateral load transfer device 910 shown in FIG. 9A, FIG. 9B, and FIG. 9C has a height (Hp) 914, a width (Wp) 912 and a thickness (Tp) 913. The dimensions of the plate are selected for optimal performance and minimum cost. The load transfer element 910 generally extends from the ground surface downward into the ground 920. The presence of the load transfer element 910 serves to increase the effective width (Bf) 906 of the flange of the piling element 900 over the depth below-grade as defined by height (Hp) 914. When loaded by lateral loads 916 and bending moments 918 the presence of the load transfer element 910 effectively increases the piling 900 width and reduces the amount of deflection associated with a given lateral load 916 or applied bending moment 918. In soft ground, this allows a smaller piling section to be used in comparison to that required to resist the lateral loads without the load transfer element. This allows for the selection of more efficient piling sections with a lower unit weight (W) and a lower section modulus (S). The triangular section of the lateral load transfer device shown in FIG. 9A, FIG. 9B, and FIG. 9C may be more efficient than other shapes relative to reducing the amount of material needed to enhance lateral load resistance.

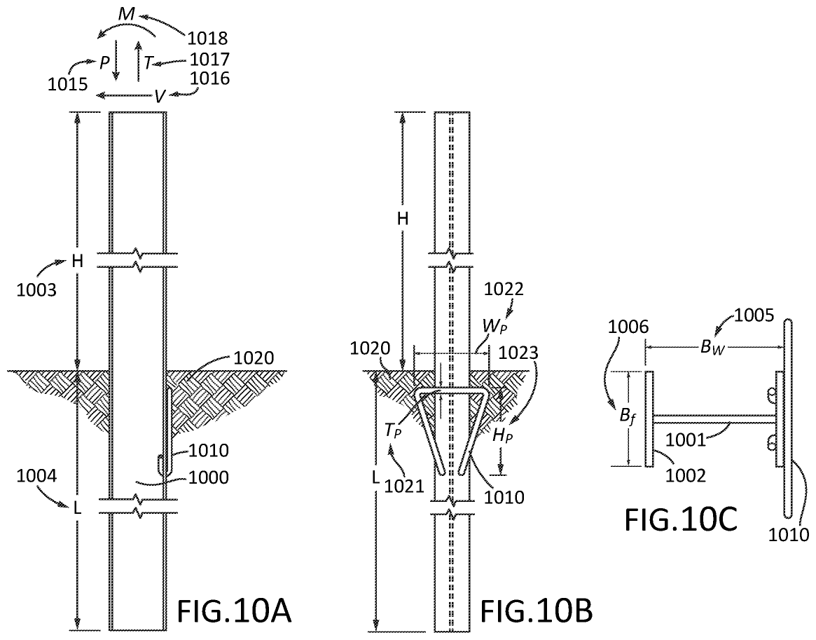

Referring now to FIG. 10A, FIG. 10B, and FIG. 10C an example configuration of still another embodiment of the present subject matter comprised of a piling section 1000 having a piling web 1001 spanning between piling flanges 1002, with a provided rack height 1003, and provided compression (P) 1015, uplift or tension (T) 1017, and lateral (V) 1016 loads, and a design dimensions (Bw) 1005 and (Bf) 1006 and properties (W) and (S) efficiently determined based on superstructure rack loads. In this embodiment, the load transfer element 1010 is comprised of a rebar element, configured to extend into holes that are cut into the piling flanges 1002 to the piling section to enhance its resistance to lateral loads 1016 and bending moments (M) 1018 in the soil profile. The current embodiment is comprised of a lateral load transfer element 1010 shown in FIG.

10A, FIG. 10B, and FIG. 10C as a generally triangular shaped load transfer element 1010 installed through holes cut into the piling flange 1002 or otherwise attached to the piling element 1000. The lateral load transfer device 1010 shown in FIG. 10A, FIG. 10B, and FIG. 10C has a height (Hp) 1023, a width (Wp) 1022 and a thickness (Tp) 1021. The dimensions of the rebar element are selected for optimal performance and minimum cost. The load transfer element 1010 generally extends from the ground surface downward into the ground 1020. The presence of the load transfer element 1010 serves to increase the effective width (Bf) 1006 of the flange of the piling section 1000 over the depth below-grade as defined by height (Hp) 1023. When loaded by lateral loads 1016 and bending moments 1018 the presence of the load transfer element 1010 effectively increases the piling 1000 width and reduces the amount of deflection associated with a given lateral load 1016 or applied bending moment 1018. In soft ground, this allows a smaller piling section to be used in comparison to that required to resist the lateral loads without the load transfer element. This allows for the selection of more efficient piling sections with a lower unit weight (W) and a lower section modulus (S). The triangular section of the lateral load transfer element 1010 shown in FIG. 10A, FIG. 10B, and FIG. 10C may be more efficient than other shapes relative to reducing the amount of material needed to enhance lateral load resistance.

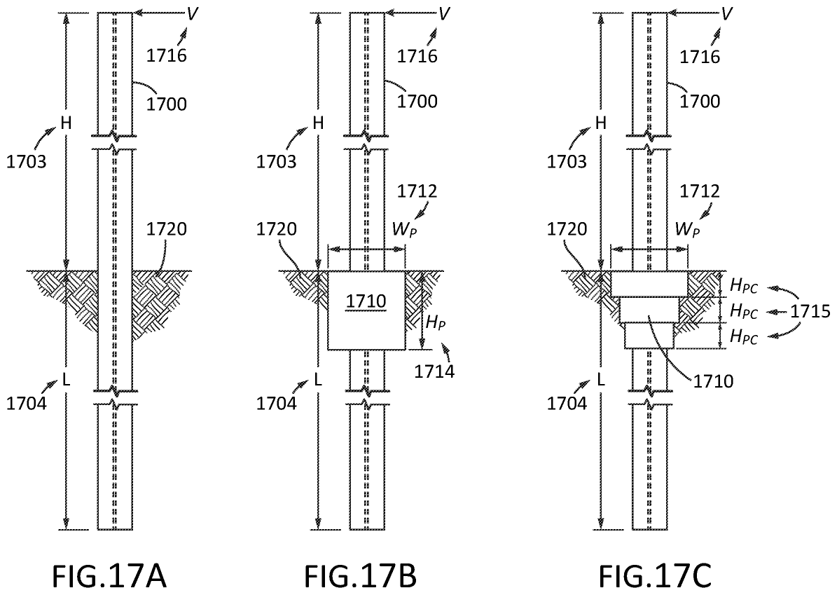

Referring now to FIG. 17A, FIG. 17B, and FIG. 17C, these figures represent the three piling sections 1700 used in the numerical analysis as described in Example 4. The three piling sections 1700 were modeled using the dimensions of a W6x9 steel pile, and had the same embedment depth (L) 1704 of 6 feet (1.8 m) into the ground 1720 and free length (H) 1703 of 5 feet (1.5 m). FIG. 17A shows a W6x9 piling section with no load transfer element installed. FIG. 17B shows a W6x9 piling section with a load transfer element 1710 similar to the load transfer element described in FIG. 8A, FIG. 8B, and FIG. 8C. This load transfer element 1710 had a width (Wp) 1712 of 12 inches (30.5 cm) and a height (Hpb) 1714 of 18 inches (45.7 cm). FIG. 17C shows a W6x9 piling section with a load transfer element 1710 similar to the load transfer element described in FIG. 9A, FIG. 9B, and FIG. 9C. This load transfer element 1710 had a starting width (Wp) 1712 of 12 inches (30.5 cm) and individual plate heights (Hpc) 1715 of 6 inches (15.2 cm). This load transfer element also was modeled in three sections (to form a triangle) due to limitations in modeling software, as further described below. An increasing lateral load (V) 1716 was applied at the top of the free length 1703 of each of the three piles and the deflection was reported.

The presently disclosed load transfer apparatus shown in FIG. 3, FIG. 4, FIG. 5, FIG. 6, FIG. 7, FIG. 8, FIG. 9, and FIG. 10 reduce the length of piling required to be driven into the soil or reduce the required section modulus(S) of the piling. Efficiency is provided when the volume of material associated with any of the load transfer elements 310, 410, 510, 610, 710, 810, 910, or 1010 relative to the entire weight of the pilings required for installation when the load transfer elements are not considered. A reduction in the volume of material, such as steel, results often in lower cost and a corresponding reduction in the environmental footprint associated with the installation of load support systems.

The load transfer elements 310, 410, 510, 610, 710, 810, 910, or 1010 may consist of materials such as steel, concrete, reinforced plastics, or other materials. The piling sections that the elements attach to may consist of structural channels, angle members, T-sections, S-sections, I-sections, W-sections, HP-sections, C-sections, or other sections commonly associated with steel shapes, such as square tubing (i.e., hollow tubing with square cross-section), rectangular tubing (i.e., hollow tubing with rectangular cross-section), piping (i.e., hollow piping with substantially circular cross-section), a solid bar of any cross-sectional shape, and the like. The cross-sectional dimensions of the load transfer elements 310, 410, 510, 610, 710, 810, 910, and 1010 may vary. In one example, the piling section is a W6x12 structural section.

The thicknesses of the load transfer elements 310, 410, 510, 610, 710, 810, 910, and 1010 may vary and are selected to provide optimal efficiency for the loads applied. In general, the thickness of the plates and rebar will be ⅛ to ½ inches thick.

The upper load transfer elements 310, 510, 610, and 910 can be mechanically coupled to the piling sections 300, 400, 500, 600, 700, 810, 900, and 1000 by, for example, bolting, welding, or by any other means, such as clips, rails, hooks, and the like. The use of any fastening methods other than welding may, advantageously, allow the load transfer elements 410, 610, 710, and 1010 to be field-assembled without the need for welding or other forms of fastening.

### Example 1

In one example, three piling sections comprised of IPE160 beams, which have similar dimensions to piling sections commonly used as photovoltaic panel supports, were installed using embodiments of the present subject matter shown in FIGS. 4A, 4B, 4C and 4D at a test site in Colombia, South America. The subsurface soil at the site consisted of organic clays of medium to high plasticity. The IPE160 piling sections had a width of 8.2 cm (3.23 inch), depth of 16 cm (6.3 inch), web thickness of 0.5 cm (0.2 inch), and flange thickness of 0.74 cm (0.29 inch). In addition to the piling sections installed with the load transfer elements (LTE) described in FIGS. 4A, 4B, 4C, and 4D, piling sections without load transfer elements were also installed and served as comparisons to illustrate the effectiveness of the present subject matter.

Rebar sections of size number 4 steel rebar (0.5 inch or 1.27 cm in diameter) and 8.75 inches (22.2 cm) in length were bent in the shape presented in FIG. 4D to create the load transfer elements. These load transfer elements were then installed in holes that were cut into the flanges of the piling section. The shape of the load transfer elements, specifically the curves presented in FIG. 4D, allowed installation through the holes within the flanges by rotating the elements about the curves while also allowing the elements to be securely hung within the holes in the flanges without the need for welding or other forms of fastening of the load transfer elements to the piling section.

Three piling sections with load transfer elements were then installed into the ground using a vibratory hammer with the ends of the piling sections terminating at 4 feet (1.22 m), 5 feet (1.52 m), and 6 feet (1.83 m) below ground surface. Three piling sections without load transfer elements were then driven adjacent to the piling sections with load transfer elements to depths of 4 feet (1.22 m), 5 feet (1.52 m), and 6 feet (1.83 m) below ground surface.

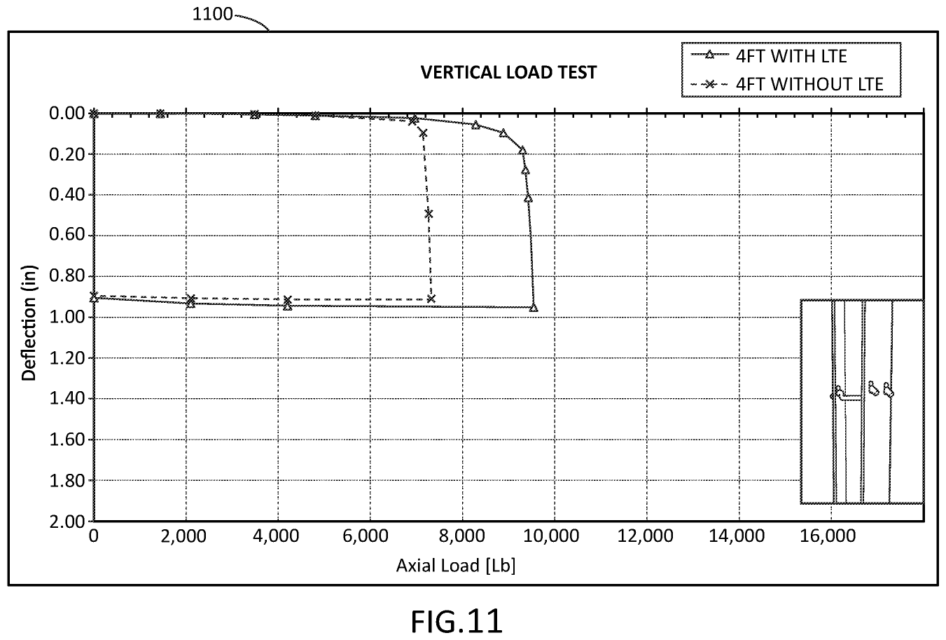

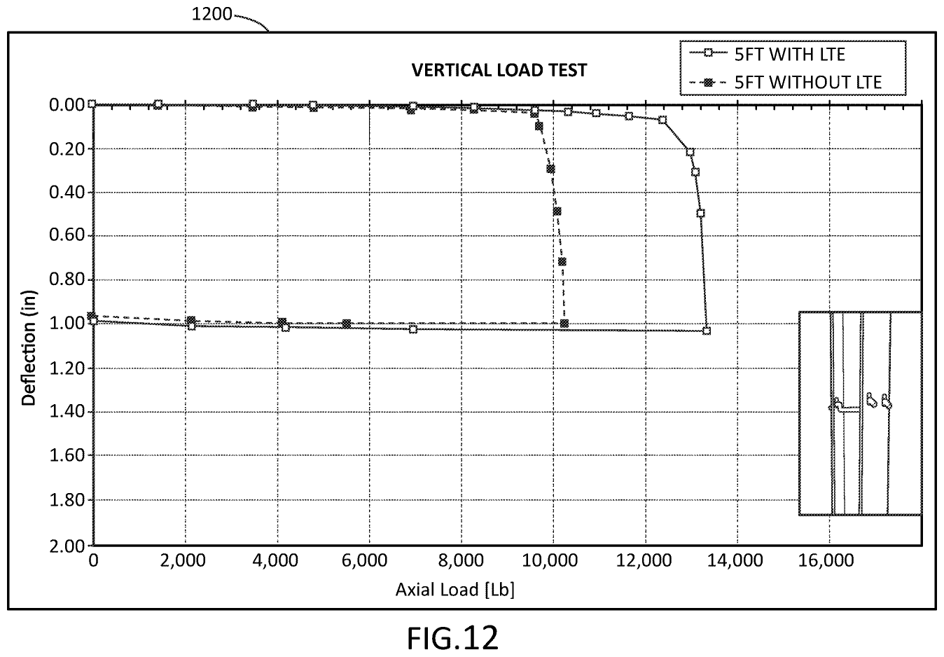

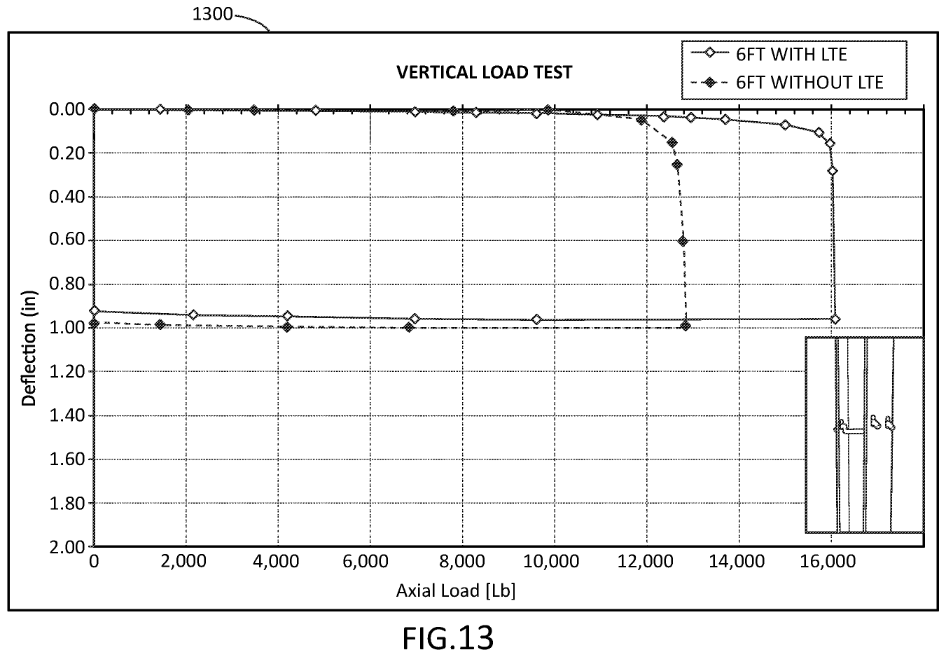

Vertical load tests were then performed on the six piling sections installed. The results 1100, 1200, and 1300 of the vertical load tests as shown in FIG. 11, FIG. 12, and FIG. 13 show that the use of the load transfer elements in the piling sections increased the vertical bearing capacity of the piling sections. As shown in FIG. 11, the vertical bearing capacity was increased from approximately 7,200 lbs to approximately 9,400 lbs for the 4-foot embedded section. This represents a 2,200 lbs or 30 percent increase in load resistance. As shown in FIG. 12, the vertical bearing capacity of the 5-foot embedded section increased from approximately 10,100 lbs to approximately 13,500 lbs, an increase of 3,400 lbs or 33 percent. As shown in FIG. 13, the vertical bearing capacity of the 6-foot embedded section increased from approximately 12,900 lbs to approximately 16,000 lbs, and increase of 3,100 lbs or 24 percent.

These results show that the use of the load transfer elements in the piling sections allow for the use of shorter piling sections to achieve similar bearing capacities. Using shorter piling sections saves time on installation, is more cost effective by requiring less materials, and also reduces the environmental impacts of the installation of photovoltaic panel support arrays.

### Example 2

In another example of the present subject matter, piling sections comprised of IPE160 beams which have similar dimensions to piling sections commonly used as photovoltaic panel supports, were installed using embodiments of the present subject matter shown in FIGS. 6A, 6B, 6C, 6D, and 6E at the same testing site as described in Example 1. The IPE 160 piling sections had a width of 8.2 cm (3.23 inch), depth of 16 cm (6.3 inch), web thickness of 0.5 cm (0.2 inch), and flange thickness of 0.74 cm (0.29 inch). In addition to the piling sections installed with the load transfer elements (LTE) described in FIGS. 6A, 6B, 6C, 6D, and 6E, one piling section without load transfer elements was also installed and served as a comparison to illustrate the effectiveness of the present subject matter.

Rebar sections of size number 4 rebar (0.5 inch or 1.27 cm in diameter) were bent in the shape presented in FIG. 6D to create the load transfer elements. The load transfer elements had an overall height of 6.5 inches (16.5 cm) and a width of 9 inches (22.9 cm). These load transfer elements were then installed in holes that were cut into the flanges of the piling section. The shape of the load transfer elements allowed the installation of the elements through these holes within the flanges while also allowing the elements to be secured within the piling section without the need for welding or other forms of fastening of the load transfer elements to the piling section.

The shape of the load transfer elements as shown in FIG. 6D allows the element to hang vertically during driving of the piling sections, limiting the increase of driving resistance as compared to a piling section without the load transfer elements. Upon uplift loading of a piling section with load transfer elements installed, the curves and the upper and lower arm heights of the load transfer element allow controlled outward rotation of the upper portion of the load transfer element. The outward rotation of the load transfer element creates a wedge of soil above the load transfer element, thereby increasing the uplift capacity of the piling section.

Two piling sections with load transfer elements were installed into the ground using a vibratory hammer with the ends of the piling sections terminating at 4 feet (1.22 m) and 5 feet (1.52 m) below ground surface. One piling section without load transfer elements was then driven adjacent to the piling sections with load transfer elements to a depth of 4 feet (1.22 m) below ground surface.

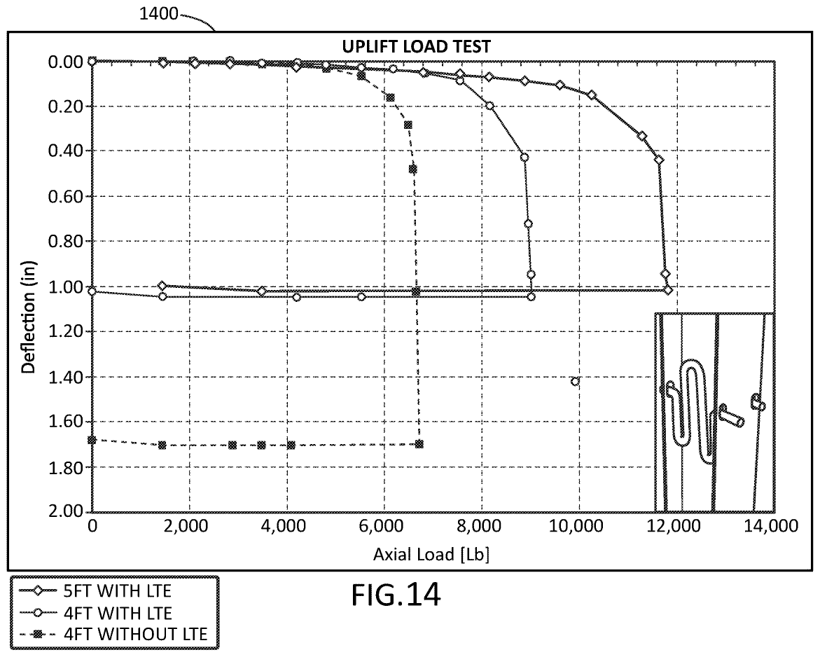

Upward load tests were then performed on the three piling sections installed. The results 1400 of the vertical load tests as shown in FIG. 14 shows that the use of the load transfer elements shown in FIGS. 6A, 6B, 6C, 6D, and 6E in the piling sections increased the vertical uplift capacity from approximately 6,700 lbs to approximately 9,000 lbs, an increase of 2,300 lbs, or 34 percent, for a 4-foot embedded section. FIG. 14 also shows a 5-foot embedded section having an uplift capacity of approximately 11,900 lbs, an increase of 5,200 lbs, or 78 percent, as compared to the 4-foot embedded section without load transfer element installed.

### Example 3

In another example of the present subject matter, two piling sections comprised of IPE160 beams which have similar dimensions to piling sections commonly used as photovoltaic panel supports, were installed using embodiments of the present subject matter shown in FIGS. 10A, 10B, and 10C at the same testing site as described in Example 1. The IPE 160 piling sections had a width of 8.2 cm (3.23 inch), depth of 16 cm (6.3 inch), web thickness of 0.5 cm (0.2 inch), and flange thickness of 0.74 cm (0.29 inch). In addition to the piling sections installed with the load transfer elements described in FIGS. 10A, 10B, and 10C, two piling sections without load transfer elements were also installed and served as comparisons to illustrate the effectiveness of the present subject matter.

Rebar sections of size number 4 rebar (0.5 inch or 1.27 cm in diameter) were bent in the shape presented in FIGS. 10A and 10B to create the load transfer elements. The load transfer elements had a height of 20 inches (50.8 cm) and a width of 10 inches (25.4 cm). These load transfer elements were then installed in holes that were cut into the flanges of the piling section. The shape of the load transfer elements allowed the installation of the elements through these holes within the flanges while also allowing the elements to be secured within the piling section without the need for welding or other forms of fastening of the load transfer elements to the piling section.

Two piling sections with load transfer elements were then installed into the ground using a vibratory hammer with the ends of the piling sections terminating at 4 feet (1.22 m) and 5 feet (1.52 m) below ground surface. Two piling sections without load transfer elements were then driven adjacent to the piling sections with load transfer elements to depths of 4 feet (1.22 m) and 5 feet (1.52 m) below ground surface.

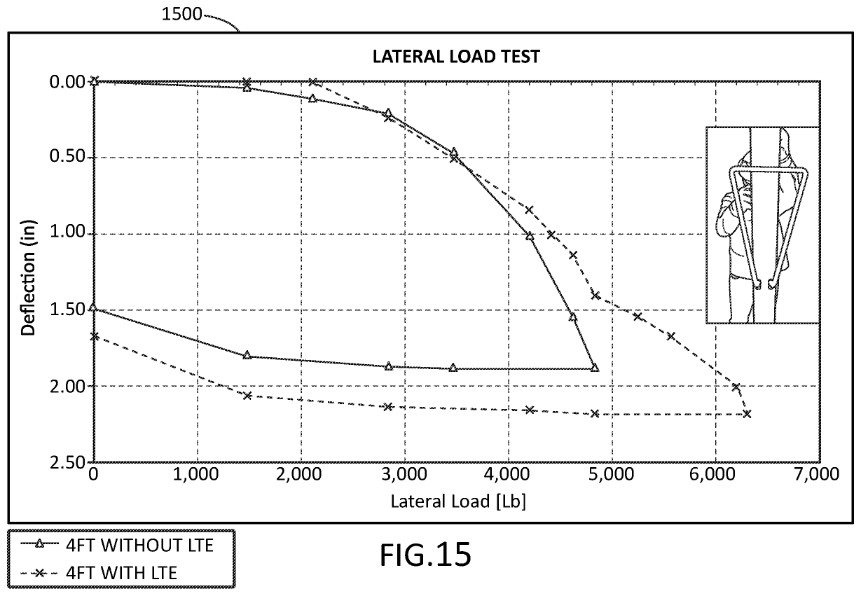

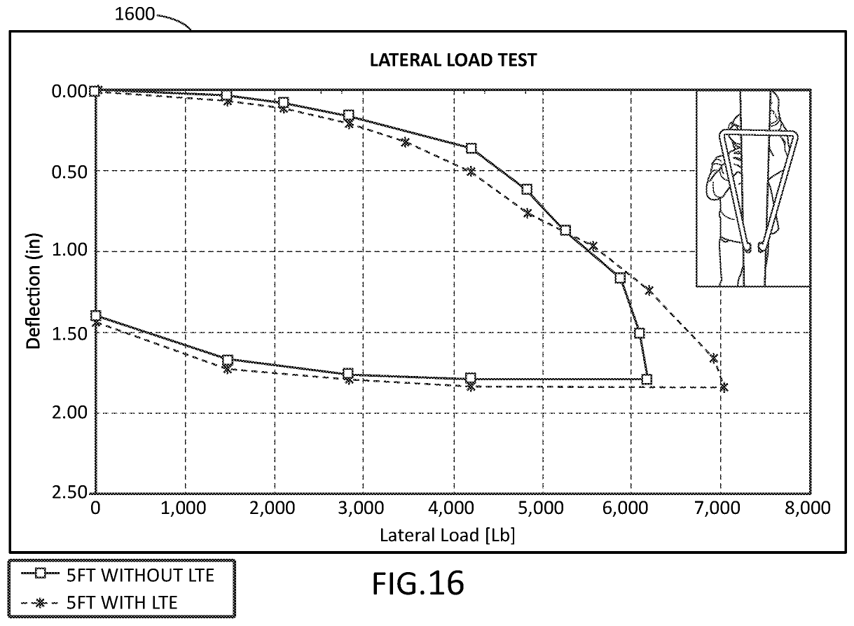

Lateral load tests were then performed on the three piling sections installed. The results 1500 and 1600 of the vertical load tests as shown in FIGS. 15 and 16 show that the use of the load transfer elements (LTE) in the piling sections increased the lateral load capacity of the piling sections from approximately 4,800 lbs to approximately 6,300 lbs for the 4-foot embedded section. This represents an increase of 1,500 lbs, or 31 percent. For the 5-foot embedded section, the lateral load capacity increased from approximately 6,200 lbs to approximately 7,000 lbs, an increase of 800 lbs, or 13 percent, in lateral load capacity.

### Example 4

The load transfer elements shown in FIGS. 8A, 8B, and 8C and FIGS. 9A, 9B, and 9C were analyzed in a numerical study in the software program LPILE, a commonly used computer program for analyzing piles subjected to lateral loads, to investigate the effectiveness of the load transfer elements in increasing the lateral load capacity of a pile section. 11 foot (3.35 m) long W6x9 steel piling sections embedded 6 feet (1.83 m) were used in the analysis with each piling section having a width of 3.94 inch (10 cm), depth of 5.9 inch (15 cm), web thickness of 0.17 inch (0.43 cm), and flange thickness of 0.215 inch (0.55 cm).

Numerical analysis was conducted on three W6x9 piling sections, one with no load transfer elements, one with a rectangular load transfer element like the embodiment shown in FIGS. 8A, 8B, and 8B, and one with a triangular load transfer element like the embodiment shown in FIGS. 9A, 9B, and 9C. The rectangular load transfer element had a height of 18 inches (45.7 cm) and a width of 12 inches (30.5 cm). The triangular load transfer element was modeled in three sections due to limitations of the LPILE software to model triangular elements. The three sections had heights of 6 inches (15.2 cm) and widths of 12 inch (30.5 cm), 10 inch (25.4 cm), and 8 inch (20.3 cm).

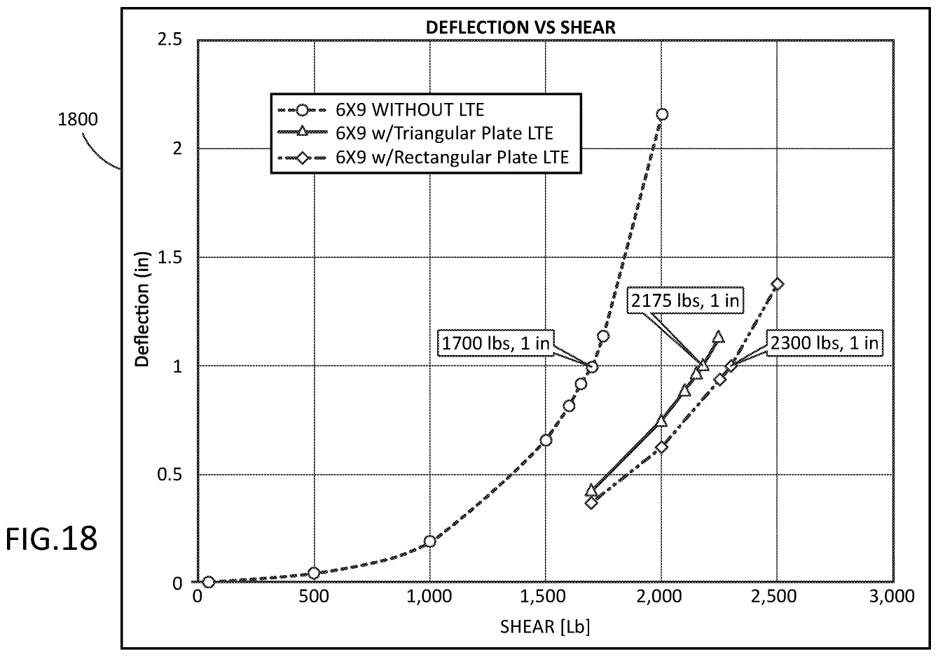

A lateral load was applied to the three piling sections at a height of 5 feet (1.52 m) above the ground surface and was increased in increments until 1 inch (2.54 cm) of deflection at the location of the applied load. The results 1800 of the numerical analysis are presented in FIG. 18. The piling sections with no load transfer element (LTE) had a lateral load resistance of 1700 lbs at 1 inch (2.54 cm) of deflection. The rectangular load transfer element shown in FIG. 17B increased the lateral load resistance of the piling section to 2300 lbs at 1 inch (2.54 cm) of deflection, an increase of 35 percent compared to the piling section without a load transfer element. The triangular load transfer element shown in FIG. 17C increased the lateral load resistance of the piling section to 2175 lbs at 1 inch (2.54 cm) of deflection, an increase of 28 percent compared to the piling section without a load transfer element.

### Embodiment Implementations

Certain implementations of apparatuses, systems, and methods consistent with the present disclosure are provided as follows:
Implementation 1. A photovoltaic panel support system comprising: a piling element adapted to be driven and extend to a depth into a ground and support a panel rack above the ground, wherein the piling element has a web spanning between two flanges and is provided with a panel rack height, an embedment length, a compression load, an uplift load, and a lateral load; and a load transfer element provided to the piling element adapted to increase resistance to one or more of the compression, uplift, and lateral loads.
Implementation 2. The system of implementation 1, wherein the load transfer element is a plate attached inside each of the two flanges within a proximal end region of the embedment length, each plate having a height and thickness adapted to provide increased resistance while driving and to act as an end bearing element resulting in increased resistance to compressive loads on the piling element once driven in the ground. Implementation 3. The system of implementation 1, wherein the load transfer element is a removable elongate member spanning between and configured to extend in to holes in the two flanges within a proximal end region of the embedment length; the elongate member adapted to provide increased resistance while driving and to increase ground lateral stresses resulting in increased resistance to compressive loads on the piling element once driven in the ground.
Implementation 4. The system of implementation 3, wherein the removable elongate member comprises a defined curve at each end for removable installation within the holes in the flanges and to provide secure attachment during driving of the piling element.
Implementation 5. The system of implementation 4, wherein the removable elongate member is made of rebar.
Implementation 6. The system of implementation 1, wherein the load transfer element is a pair of plates, including an inner plate and an outer plate, in the area between the web and each of the two flanges within a distal end region of the embedment length; the inner plate being proximal towards the web and the outer plate being distal away from the web; and the plates being adapted to provide uplift resistance to the piling element once driven in the ground.
Implementation 7. The system of implementation 1, wherein the load transfer element is a removable and rotatable serpentine member spanning between and configured to extend in to holes in the two flanges within a distal end region of the embedment length; the serpentine member configured to remain vertical during driving of the piling element to provide minimal resistance in the ground, and the serpentine member further configured to rotate outwardly during uplift loading to increase uplift resistance to the piling element once driven in the ground.
Implementation 8. The system of implementation 7, wherein the removable generally serpentine member is made of rebar.
Implementation 9. The system of implementation 1, wherein the load transfer element is a movable elongate member spanning between the two flanges within a distal end region of the embedment length, wherein each elongate member is installed within upwardly inclined slots within each flange, and further wherein each elongate member is configured to translate upward in the inclined slot and close to the web during driving of the piling element to provide minimal resistance in the ground, and each elongate member is further configured to translate downward in the inclined slot and away from the web during uplift loading to increase uplift resistance to the piling element once driven in the ground.
Implementation 10. The system of implementation 9, wherein the elongate member is made of rebar.
Implementation 11. The system of implementation 1, wherein the load transfer element is a plate mechanically coupled to at least one of flanges of the piling element within a proximal end region of the embedment length, the plate having a width, a length, and an orientation; the plate adapted to provide resistance to lateral loads on the piling element once driven in the ground.
Implementation 12. The system of implementation 11, wherein the plate is attached outside one of the two flanges along the embedment length.
Implementation 13. The system of implementation 11, wherein the plate is mechanically coupled to the piling element flange by bolting, welding, clips, rails, or hooks. Implementation 14. The system of implementation 11, wherein the plate has a rectangular shape.
Implementation 15. The system of implementation 11, wherein the plate has a triangular shape.
Implementation 16. The system of implementation 1, wherein the load transfer element is a removable triangular shaped member inserted through holes in and attached to at least one of flanges of the piling element within a proximal end region of the embedment length; the triangle shaped member adapted to provide resistance to lateral loads on the piling element once driven in the ground.
Implementation 17. The system of implementation 16, wherein the removable triangular shaped member is made of rebar.
Implementation 18. A photovoltaic panel support apparatus comprising: a panel rack attached to one or more panels; a vertical support section adapted for embedment into a ground and for supporting the one or more panels above the ground, the vertical support section having a panel rack height, an embedment length, a compression load, an uplift load, and a lateral load; and a load transfer element provided to the vertical support section and adapted to adapted to increase resistance to one or more of the compression, uplift, and lateral loads.
Implementation 19. The apparatus of implementation 18, wherein the vertical support section is a pile with a web spanning between two flanges.
Implementation 20. The apparatus of implementation 19, wherein the load transfer element is attached to the inside of one or both of the two flanges along the embedment length.
Implementation 21. The apparatus of implementation 19, wherein the load transfer element is attached to the outside of one or both of the two flanges along the embedment length.
Implementation 22. A method of constructing photovoltaic panel farms, comprising the steps of: providing a series of photovoltaic panels, a panel rack and a panel support, the panel support having a piling section and a load transfer element, wherein the piling section is adapted to extend to a depth into a ground and support the panel rack above the ground, wherein the piling section has a web spanning between two flanges and is provided with a panel rack height, an embedment length, a compression load, an uplift load, and a lateral load, and wherein the load transfer element is provided to the piling section and adapted to increase resistance to one or more of the compression, uplift, and lateral loads; embedding the panel support into the ground; and attaching the photovoltaic panels and panel rack to the panel support.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, parameters, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

We claim:

1. A photovoltaic panel support system comprising:
a piling element adapted to be driven and extend to a depth into a ground and support a panel rack above the ground, wherein the piling element has a web spanning between two flanges and is provided with a panel rack height, an embedment length, a compression load, an uplift load, and a lateral load; and
a load transfer element provided to the piling element adapted to increase resistance to one or more of the compression, uplift, and lateral loads.

2. The system of claim 1, wherein the load transfer element is a plate attached inside each of the two flanges within a proximal end region of the embedment length, each plate having a height and thickness adapted to provide increased resistance while driving and to act as an end bearing element resulting in increased resistance to compressive loads on the piling element once driven in the ground.

3. The system of claim 1, wherein the load transfer element is a removable elongate member spanning between and configured to extend in to holes in the two flanges within a proximal end region of the embedment length; the elongate member adapted to provide increased resistance while driving and to increase ground lateral stresses resulting in increased resistance to compressive loads on the piling element once driven in the ground.

4. The system of claim 3, wherein the removable elongate member comprises a defined curve at each end for removable installation within the holes in the flanges and to provide secure attachment during driving of the piling element.

5. The system of claim 4, wherein the removable elongate member is made of rebar.

6. The system of claim 1, wherein the load transfer element is a pair of plates, including an inner plate and an outer plate, in the area between the web and each of the two flanges within a distal end region of the embedment length; the inner plate being proximal towards the web and the outer plate being distal away from the web; and the plates being adapted to provide uplift resistance to the piling element once driven in the ground.

7. The system of claim 1, wherein the load transfer element is a removable and rotatable serpentine member spanning between and configured to extend in to holes in the two flanges within a distal end region of the embedment length; the serpentine member configured to remain vertical during driving of the piling element to provide minimal resistance in the ground, and the serpentine member further configured to rotate outwardly during uplift loading to increase uplift resistance to the piling element once driven in the ground.

8. The system of claim 7, wherein the removable generally serpentine member is made of rebar.

9. The system of claim 1, wherein the load transfer element is a movable elongate member spanning between the two flanges within a distal end region of the embedment length, wherein each elongate member is installed within upwardly inclined slots within each flange, and further wherein each elongate member is configured to translate upward in the inclined slot and close to the web during driving of the piling element to provide minimal resistance in the ground, and each elongate member is further configured to translate downward in the inclined slot and away from the web during uplift loading to increase uplift resistance to the piling element once driven in the ground.

10. The system of claim 9, wherein the elongate member is made of rebar.

11. The system of claim 1, wherein the load transfer element is a plate mechanically coupled to at least one of flanges of the piling element within a proximal end region of the embedment length, the plate having a width, a length, and an orientation; the plate adapted to provide resistance to lateral loads on the piling element once driven in the ground.

12. The system of claim 11, wherein the plate is attached outside one of the two flanges along the embedment length.

13. The system of claim 11, wherein the plate is mechanically coupled to the piling element flange by bolting, welding, clips, rails, or hooks.

14. The system of claim 11, wherein the plate has a rectangular shape.

15. The system of claim 11, wherein the plate has a triangular shape.

16. The system of claim 1, wherein the load transfer element is a removable triangular shaped member inserted through holes in and attached to at least one of flanges of the piling element within a proximal end region of the embedment length; the triangle shaped member adapted to provide resistance to lateral loads on the piling element once driven in the ground.

17. The system of claim 16, wherein the removable triangular shaped member is made of rebar.

18. A photovoltaic panel support apparatus comprising:
a panel rack attached to one or more panels;
a vertical support section adapted for embedment into a ground and for supporting the one or more panels above the ground, the vertical support section having a panel rack height, an embedment length, a compression load, an uplift load, and a lateral load; and
a load transfer element provided to the vertical support section and adapted to adapted to increase resistance to one or more of the compression, uplift, and lateral loads.

19. The apparatus of claim 18, wherein the vertical support section is a pile with a web spanning between two flanges.

20. The apparatus of claim 19, wherein the load transfer element is attached to the inside of one or both of the two flanges along the embedment length.

21. The apparatus of claim 19, wherein the load transfer element is attached to the outside of one or both of the two flanges along the embedment length.

22. A method of constructing photovoltaic panel farms, comprising the steps of:
providing a series of photovoltaic panels, a panel rack and a panel support, the panel support having a piling section and a load transfer element, wherein the piling section is adapted to extend to a depth into a ground and support the panel rack above the ground, wherein the piling section has a web spanning between two flanges and is provided with a panel rack height, an embedment length, a compression load, an uplift load, and a lateral load, and wherein the load transfer element is provided to the piling section and adapted to increase resistance to one or more of the compression, uplift, and lateral loads;
embedding the panel support into the ground; and
attaching the photovoltaic panels and panel rack to the panel support.
